(19) United States
(12) Patent Application Publication
(10) Pub. No.: US 2025/0156872 A1
(43) Pub. Date: May 15, 2025

(54) AUTOMATIC FRAUD DETECTION USING MACHINE LEARNING

(71) Applicant: Capital One Services, LLC, McLean, VA (US)

(72) Inventor: Vishal Bahirwani, North Potomac, MD (US)

(21) Appl. No.: 18/507,600

(22) Filed: Nov. 13, 2023

(51) Int. Cl. G06Q 20/40

(52) U.S. Cl. CPC G06Q 20/4016

(57) ABSTRACT

Aspects described herein may automatically detect first-person fraud. A computing device may receive activity instances associated with a first user at different times, and aggregate, via an application programming interface (API), the instances by normalizing attributes associated with the activity instances that indicate fraud. The computing device may input the normalized attributes into a machine model to predict a likelihood of a future fraud instance. The computing device may send, based on the likelihood exceeding a threshold, an alert. In this way, fraud instances may be detected promptly.

### FIELD OF USE

Aspects of the disclosure relate generally to data processing. More specifically, aspects of the disclosure may provide for systems and methods for detecting fraud instances.

### BACKGROUND

First party fraud may involve fraudulent activities carried out by individuals using their own identities, as opposed to identity thieves who commit fraudulent acts using someone else's identity. For example, a user may commit application fraud by misrepresenting the user's financial standing when the user applies for a financial account. In another example, a user may commit loan stacking by quickly applying for multiple loans from different lenders in a short period of time, before the first loan appears on the user's credit report. First party fraud may result in significant losses for financial institutions and may be challenging to detect before the losses become apparent. An effective way is needed to detect first party fraud instances at an early stage.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Detecting first party fraud may be difficult before fraudulent activities are clearly visible, such as before the fraudulent user disappears leaving a substantial amount of unpaid debts. Detecting first party fraud may be difficult, for example, because some activities conducted during the fraud scheme may seem legitimate when viewed in isolation. For example, an individual may make payments consistently for a period to increase the user's credit limit with the ultimate goal of, after the credit limit is sufficiently high, borrowing a large sum of money without intending to pay it back. This fraudulent scheme may be difficult to detect because the actions of increasing credit limits may appear legitimate. Other activities, while not legitimate, may be difficult to identify because they are not reported by victims. For example, a user may fake tradelines to inflate the user's credit score. While these fake tradelines are fraudulent in nature, detecting the fake tradelines may be difficult because financial institutions may not receive any reports from victims. Furthermore, even if the financial institution detects one of the fake tradelines, the financial institution may view the detected fake tradeline as an isolated suspicious transaction, unable to link the detected fake tradeline to the broader first party fraud scheme. An effective way is needed to automatically detect fraudulent activities (e.g., first party fraudulent activities) before the losses become substantial.

To overcome limitations in the prior art described above, and to overcome other limitations that will be apparent upon reading and understanding the present specification, aspects described herein are directed towards predicting a future fraud instance. In at least some embodiments, a computing device may receive, from a second computing device, a first activity instance, associated with a first user, at a first time, and may receive, from a third computing device, a second activity instance, associated with the first user, at a second time. The computing device may aggregate, via an application programming interface (API), the first activity instance and the second activity instance by normalizing: one or more first attributes associated with the first activity instance; and one or more second attributes associated with the second activity instance. The computing device may determine, by inputting the one or more first normalized attributes and the one or more second normalized attributes into a machine model, a first likelihood of a future fraud instance associated with the first user, wherein the machine learning model is trained to output, based on an input of normalized attributes associated with each of a plurality of fraud instances, a likelihood of a future fraud instance of a user associated with the plurality of input fraud instances. The computing device may send, based on the first likelihood exceeding a threshold, an alert.

The computing device may determine the first likelihood by using the machine learning model to: assign, based on the first activity instance belonging to a first fraud category, a first weight to the one or more first normalized attributes; assign, based on the second activity instance belonging to a second fraud category, a second weight to the one or more second normalized attributes, wherein the first weight is different from the second weight; and determine, based on the first weight and the second weight, the likelihood.

The first fraud category may be one of: a payment fraud, an application fraud, or a transaction fraud. The first activity instance may be associated with a suspected fraud action, and the second activity instance may be associated with a confirmed fraud action. The computing device may determine the likelihood based on a time duration between the first time and the second time.

The one or more first attributes may comprise a first risk score determined by a second machine learning model trained to predict a risk score associated with fraud instances of a first fraud category; and the one or more second attributes may comprise a second risk score determined by a third machine learning model trained to predict a risk score associated with fraud instances of a second fraud category.

The computing device may further send a request to take a remedial action that comprises at least one of: denial of a future transaction request; or suspending an account associated with the first user.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example of a computing environment in accordance with one or more illustrative aspects discussed herein;

FIG. 3A depicts an example of deep neural network architecture for a machine learning model according to one or more aspects of the disclosure;

FIG. 3B depicts example models for fraud detection according to one or more aspects of the disclosure;

FIG. 4 is a flow diagram of an example method for fraud detection in accordance with one or more illustrative aspects discussed herein;

FIG. 5A is a flow diagram of an example method for fraud detection in accordance with one or more illustrative aspects discussed herein;

FIG. 5B is an illustrative data table in accordance with one or more illustrative aspects discussed herein.

### DETAILED DESCRIPTION

In the following description of the various embodiments, reference is made to the accompanying drawings, which form a part hereof, and which are shown by way of illustration of various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

Each of a plurality of computing systems/devices may be configured to process a particular type of financial request (e.g., account applications, transaction requests, etc.) and/or to detect a corresponding type of fraud (e.g., falsifying application information, unauthorized transactions, etc.). The plurality of computing systems/devices may not share data with each other. For example, the plurality of computing systems/devices may not share data with each other because data that each of the plurality of computing systems/devices produces to record an activity instance (e.g., a fraud instance) may be in a different format. Activity instances recorded in different formats may not be used together, which may undermine the ability to accurately predict future fraud instances by viewing the interrelationship between the records together. As described herein, a first computing device may be configured to collect activity instances (e.g., fraud instances) that are recorded by the plurality of computing systems/devices, for example, via an application programming interface (API). The first computing device may normalize the activity instances into a standard format, and send the normalized activity instances to a machine learning model. If the machine learning model determines that a plurality of activity instances, indicated by the normalized data associated with a first user, viewed together, indicate a high likelihood of a fraudulent instance (e.g., a future fraudulent instance or an ongoing fraudulent instance that has not become apparent), the machine learning model may output the result to the first computing device. The first computing device may send alerts and/or take preventive and/or remedial actions accordingly. The machine learning model may be trained to synchronize and/or utilize risk scores calculated by different computing systems that use existing models configured to detect a single category of fraud instance. The machine learning model may be trained to analyze a relationship (e.g., a temporal relationship) between different activity instances to detect a future fraud instance or an ongoing fraud instance. The machine learning model may be optimized based on the feedback indicating whether an output result is accurate or not.

Aspects discussed herein may improve the functioning of a computer system because the computing system may use data, produced by different subsystems/devices in different formats, to make a prediction based on a machine learning model. Additionally or alternatively, aspects discussed herein may improve the functioning of data technologies because pieces of user data that were traditionally viewed as irrelevant to each other may be aggregated to produce useful predictions.

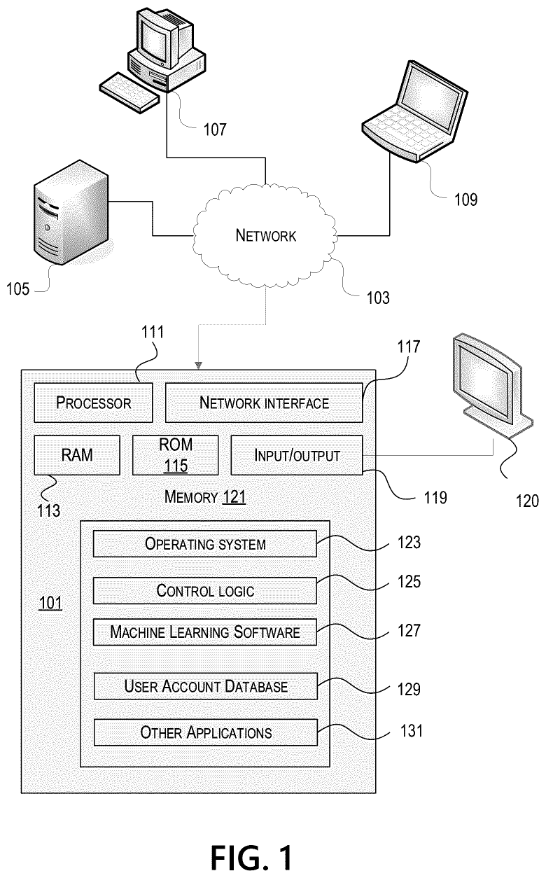

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading or executing instructions and performing one or more actions based on the instructions. In some embodiments, computing device 101 may represent, be incorporated in, or include various devices such as a desktop computer, a computer server, a mobile device (e.g., a laptop computer, a tablet computer, a smartphone, any other type of mobile computing devices, and the like), or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), or other processing units such as a processor adapted to perform computations associating converting information, routing copies of messages, or other functions described herein. I/O 119 may include a variety of interface units and drives for reading, writing, displaying, or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling the overall operation of the computing device 101, control logic 125 for instructing computing device 101 to perform aspects discussed herein. Furthermore, memory 121 may store various databases and applications depending on the particular use, for example, machine learning software 127, user account database 129, and other applications 131 may be stored in the memory of a computing device used at a server system that will be described further below. Control logic 125 may be incorporated in or may comprise a linking engine that updates, receives, or associates various information stored in the memory 121. In other embodiments, computing device 101 may include two or more of any or all of these components (e.g., two or more processors, two or more memories, etc.) or other components or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, devices 101, 105, 107, 109, and others may operate in concert to provide parallel computing features in support of the operation of control logic 125.

One or more aspects discussed herein may be embodied in computer-usable or readable data or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer-readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field-programmable gate arrays (FPGA), and the like. Particular data structures may be used to more effectively implement one or more aspects discussed herein, and such data structures are contemplated within the scope of computer-executable instructions and computer-usable data described herein. Various aspects discussed herein may be embodied as a method, a computing device, a data processing system, or a computer program product.

The data transferred to and from various computing devices may include secure and sensitive data, such as confidential documents, customer personally identifiable information, and account data. Therefore, it may be desirable to protect transmissions of such data using secure network protocols and encryption, or to protect the integrity of the data when stored on the various computing devices. A file-based integration scheme or a service-based integration scheme may be utilized for transmitting data between the various computing devices. Data may be transmitted using various network communication protocols. Secure data transmission protocols or encryption may be used in file transfers to protect the integrity of the data such as, but not limited to, File Transfer Protocol (FTP), Secure File Transfer Protocol (SFTP), or Pretty Good Privacy (PGP) encryption. In many embodiments, one or more web services may be implemented within the various computing devices. Web services may be accessed by authorized external devices and customers to support input, extraction, and manipulation of data between the various computing devices. Web services built to support a personalized display system may be cross-domain or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, or firewalls. Such specialized hardware may be installed and configured in front of one or more computing devices such that any external devices may communicate directly with the specialized hardware.

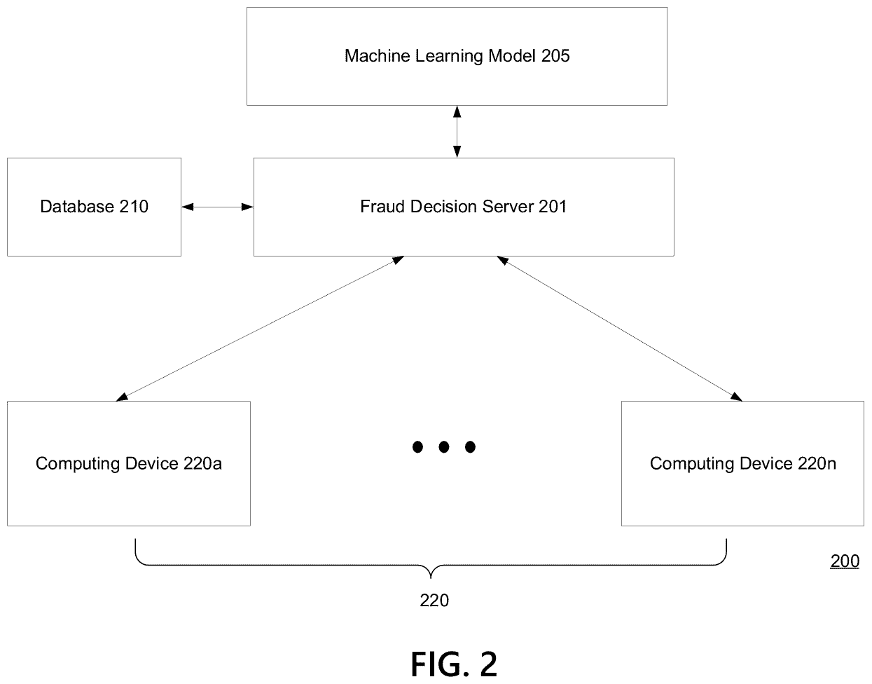

FIG. 2 depicts an illustrative computing environment for detecting fraud instances in accordance with one or more example embodiments. Referring to FIG. 2, computing environment 200 may include a fraud decision server 201, a machine learning model 205, a database 210, and a plurality of computing devices 220 (e.g., computing devices 220a-220n). Each of the fraud decision server 201, the database 210, and the plurality of computing devices 220 may be a computing device 101 as described in FIG. 1. The machine learning model 205 may be operated on a computing device 101 as described in FIG. 1. The computing device that executes the machine learning model 205 may be the same physical device as the fraud decision server 201, other computing devices depicted in FIG. 2, or any other computing devices. Each of the fraud decision server 201, the database 210, and the plurality of computing devices 220 may communicate with other devices via network 103 as described in FIG. 1.

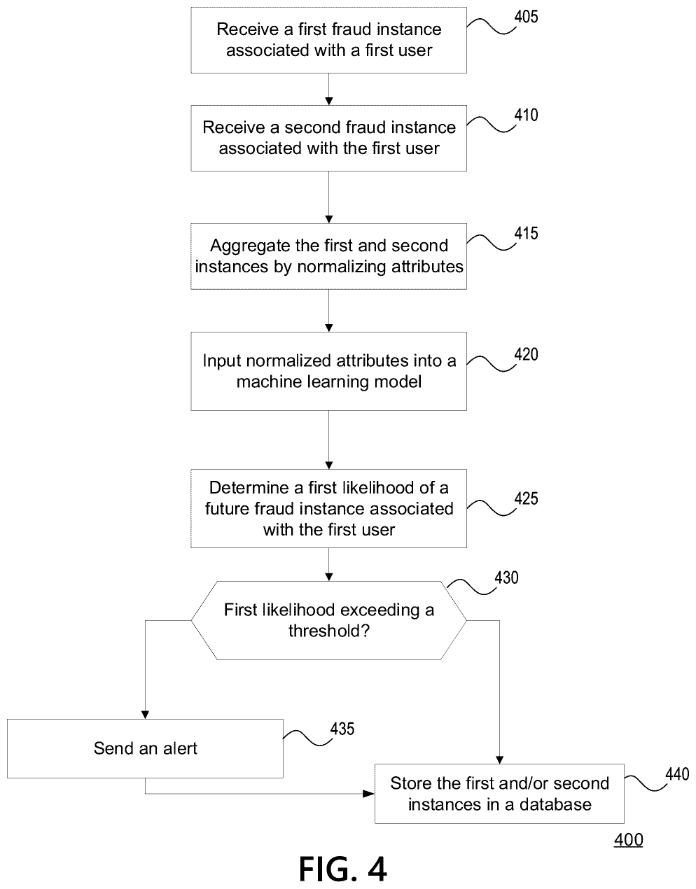

The plurality of computing devices 220 may be computing devices (e.g., servers) associated with a financial institution. Each of the plurality of computing devices may be configured to communicate with user devices (not shown in FIG. 2) to process user requests associated with user accounts. For example, the computing device 220a may be a server that processes applications to open a new user account (e.g., a credit card account). In another example, the computing device 220n may be a server that processes (e.g., authenticates) transaction requests associated with a user account. Each of the computing devices 220 may send (e.g., report), to the fraud decision server 201, activity instances the respective computing device 220 receives. For example, the computing device 220a may receive a request from the first user to open a user account. The computing device 220a may send, to the fraud decision server 201, information (e.g., one or more first attributes, as described in greater detail in FIG. 4) associated with the request to open the user account. The information may facilitate the fraud decision server 201 to determine, whether the request to open the user account (e.g., either viewed individually or collectively in combination with other activity instances) indicates that the first user has a high likelihood of committing fraud (e.g., first party fraud) in a future time point and/or a high likelihood of engaging in ongoing fraud.

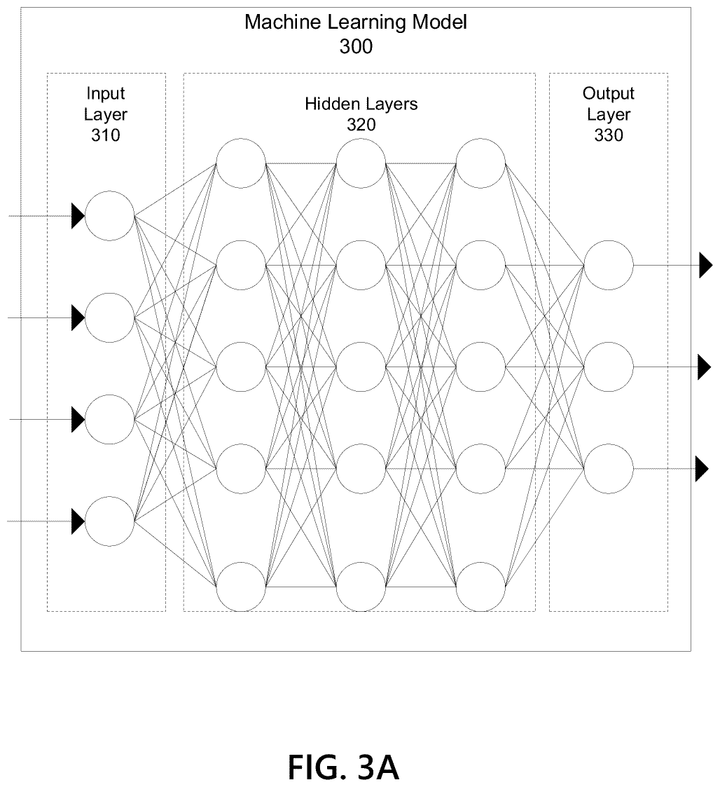

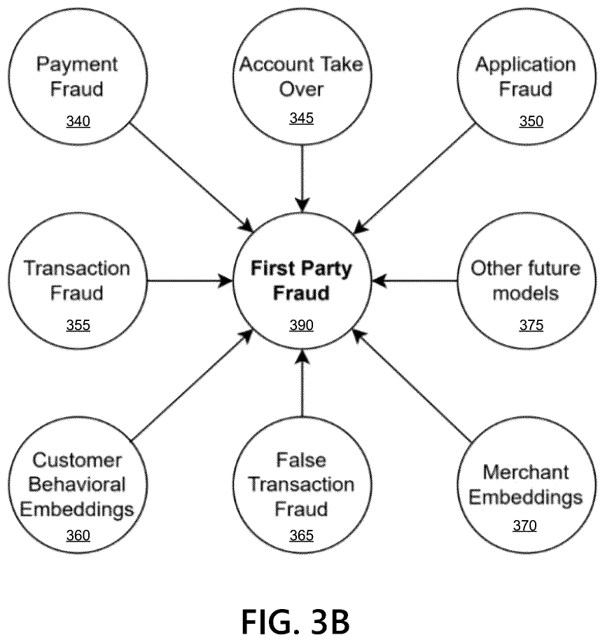

Each of the computing device 220 may send, to the fraud decision server 201, one, some, or all activity instances that the respective computing device 220 processes. A computing device 220 may select activity instances that are suspected to be fraudulent and send the suspected activity instances to the fraud decision server 201. For example, the computing device 220a may select account-opening requests that include misrepresentations of the corresponding user's financial circumstances. The computing device 220a may send the misrepresented account-opening requests to the fraud decision server 201. In another example, the computing device 220n may select transactions that the computing device 220n declines due to safety concerns. The computing device 220n may send the declined transactions to the fraud decision server 201. A computing device 220 may be communicatively connected with a fraud detection model (e.g., as depicted in FIG. 3B below) to conduct a preliminary risk analysis. As described in greater detail in FIG. 3B, the fraud detection model may be configured to detect risk in a particular type of activity. A computing device 220 may select the activities that are determined as risky based on the preliminary risk analysis. The computing device 220 may send, to the fraud decision server 201, the risky activity instances for further analysis.

While each of the individual activity instances may not be enough to determine whether a fraud occurs or is likely to occur, the fraud decision server 201 may predict a future fraud instance (or an ongoing fraud instance) by analyzing a plurality of activity instances by viewing the plurality of activity instances collectively. For example, a misrepresentation a user made when the user opens an account may not be enough to determine that the user is likely to commit fraud, as the user's misrepresentation may be made out of a mistake. In another example, a transaction that is denied because of a suspicious transaction location (e.g., far away from the user's home) may not be enough to determine a first party fraud, as the user may be traveling. The fraud decision server 201, by collecting the individual activity instances and inputting these activity instances into a machine learning model 205, may be able to predict a fraud instance more accurately and more promptly. The machine learning model 205 may utilize the relationship between the activity instances, which produces more accurate results than having the plurality of computing devices 220 analyzing each activity instance in isolation. For example, viewing the misrepresentation and the denied transaction together, the fraud decision server 201 may determine a high likelihood of a future fraud instance.

Database 210 may be communicatively connected with the fraud decision server 201. The database 210 may be configured to store activity instances associated with each user. For example, if a fraud decision server 201 receives an activity instance from a computing device 220, the fraud decision server 201 may analyze the activity instance, and send the activity instance for storage. The fraud decision server 201 may retrieve the stored activity instances from the database 210 at a later time point, for example, if the fraud decision server 201 receives a new activity instance associated with the same user. By retrieving stored activity instances and analyzing the previously stored activity instances together with new activity instances, the fraud decision server 201 may increase the accuracy of the prediction by utilizing the connection (e.g., category relationship, temporal relationship, etc.) between the previous and the new instances.

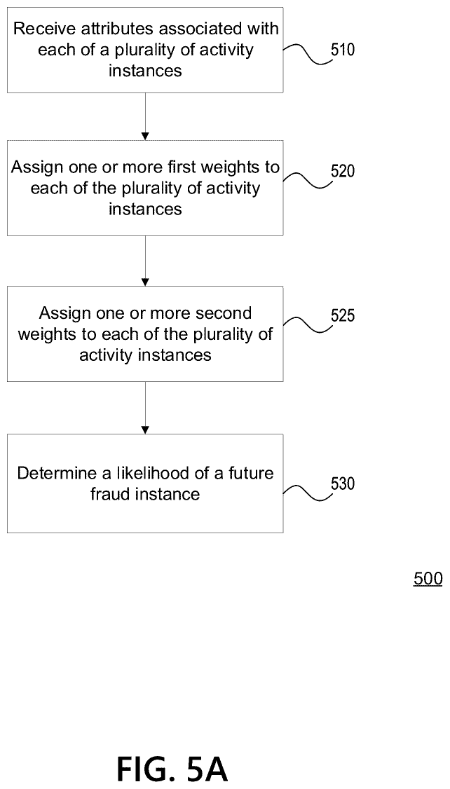

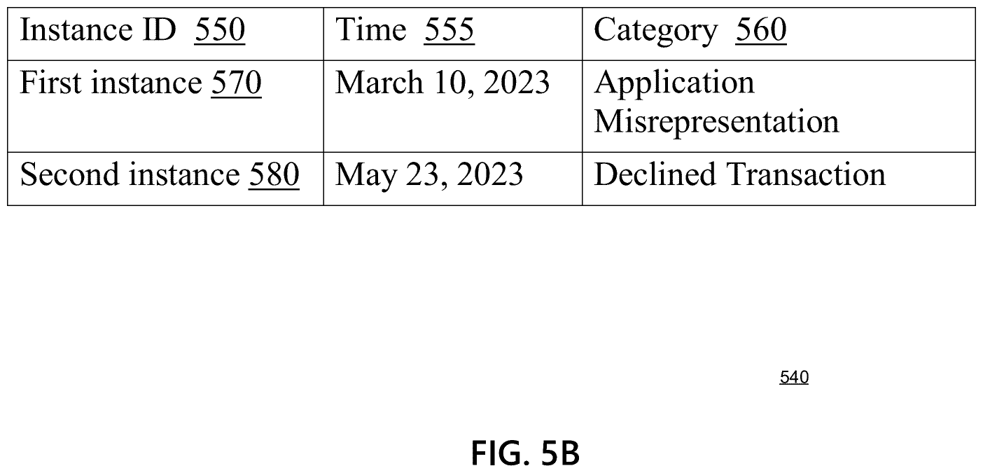

FIG. 3A illustrates an example of machine learning model 300. The machine learning model 300 may comprise one or more neural networks, including but limited to: a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), a consistent adversarial network (CAN) (e.g., a cyclic generative adversarial network (C-GAN), a deep convolutional GAN (DC-GAN), GAN interpolation (GAN-INT), GAN-CLS, a cyclic-CAN (e.g., C-CAN), etc.), or any equivalent thereof. Additionally or alternatively, the machine learning model 300 may comprise one or more decision trees. In some instances, the one or more machine learning model 300 may comprise a Hidden Markov Model. Such a machine learning model architecture may be all or portions of the machine learning software 127 shown in FIG. 1. The machine learning model 300 may be all or portions of the machine learning model 205 described in connection with FIG. 2, FIG. 4, and/or FIG. 5A. The architecture depicted in FIG. 3A need not be performed on a single computing device, and may be performed by, e.g., a plurality of computers (e.g., one or more of the devices 101, 105, 107, 109). The machine learning model 300 may comprise one or more artificial neural networks. The artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 310, one or more hidden layers 320, and an output layer 330. A deep neural network, as used herein, may be an artificial network that has more than one hidden layer. Illustrated network architecture 300 is depicted with three hidden layers, and thus may be considered a deep neural network. The number of hidden layers employed in the deep neural network 300 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The machine learning model 300 may be initialized with a random or white noise set of initial model parameters. The model parameters may then be iteratively adjusted using, for example, stochastic gradient descent algorithms that seek to minimize errors in the model.

FIG. 3B depicts an example of a plurality of fraud detection models in accordance with one or more illustrative aspects discussed herein. Each of the payment fraud model 340, account takeover model 345, application fraud model 350, transaction fraud model 355, customer behavioral embeddings model 360, false transaction model 365, and merchant embeddings model 370 may be a fraud detection model configured to detect a particular type of fraud based on a particular activity instance. For example, the payment fraud model 340 may be configured to detect illegitimate or false payment transactions (e.g., using stolen credit card details, issuing fraudulent checks, etc.). The account takeover model 345 may be configured to detect a user obtaining unauthorized access to another user's account to make unauthorized transactions. The application fraud model 350 may be configured to detect fraud at the time of application for a financial product or service (e.g., by falsifying personal or financial information). The transaction fraud model 355 may be configured to detect fraudulent activity in particular transactions (e.g., initiating unauthorized transactions). The customer behavioral embeddings model 360 may be configured to analyze users' ordinary behavior patterns and spot unusual behaviors that deviate from the ordinary patterns. The false transaction model 365 may be configured to detect fictitious transactions (e.g., to launder money or inflate revenues). The merchant embedding model 370 may be configured to detect a sudden change in a merchant's transaction patterns. Other future models 375 may be one or more other models each configured to detect another category of fraud not specified in FIG. 3B.

Each of the models 340 to 375 may be communicatively connected with a computing device 220 as depicted in FIG. 2. Consistent with the example described in FIG. 2, the application fraud model 350 may be communicatively connected with a computing device 220a that processes applications of new user accounts, for example, to identify misrepresentations made during the application process. The transaction fraud model 355 may be communicatively connected with a computing device 220n configured to authenticate transactions, for example, to detect unauthorized transactions.

Each of the models 340 to 375 may use a different data format to output the activity instances and/or the corresponding risks (e.g., evaluated based on viewing each individual activity instance alone). The plurality of computing devices 220a to 220n may not share data with each other, for example, because data in different formats may not be used together. The activity instances and/or corresponding risks may not be used to predict the future fraud of the user. Accordingly, there may be a need to collect the activity instances and risks determined by each individual model, so that the collected data may be input to a machine learning model to predict a future fraud of a user, for example, by viewing the instances and risks, identified by each individual model, together. As described herein, activity instances that are determined to be suspicious may be sent, for example, via the computing devices 220a to 220n, to the fraud decision server 201. The fraud decision server 201 may input the activity instances to the machine learning model 205 (e.g., a first party fraud model 390), for example, after normalizing data associated with the activity instances via an API. The machine learning model 205 may analyze different activities, detected over a time period, so that activity instances that were traditionally viewed in isolation may be utilized collectively (e.g., by analyzing the connection among the instances) to predict fraud instances.

FIG. 4 is a flow diagram depicting method 400 for fraud detection in accordance with one or more illustrative aspects discussed herein. The steps in method 400 may be performed by a system comprising, for example, fraud decision server 201 and the machine learning model 205 as may be shown in FIG. 2.

At step 405, a first computing device (e.g., the fraud decision server 201 depicted in FIG. 2) may receive a plurality of activity instances associated with a first user. The plurality of activity instances may comprise a first activity instance. The first activity instance may occur or be detected at a first time. The first activity instance may be received from a second computing device that executes one of the fraud models 345 to 375 in FIG. 3B. For example, the second computing device may be one of computing devices 220a to 220n as depicted in FIG. 2. The first computing device may determine, for each of the plurality of activity instances, a category. For example, the first computing device may determine that the first activity instance belongs to the first category. The first category may be at least one of: a payment fraud, an application fraud, or a transaction fraud. For example, the first activity instance may be a misrepresentation made by a first user during an application of a bank account.

The first computing device may receive one or more attributes from each of the plurality of activity instances. The one or more attributes may comprise at least one of: a time associated with the activity instance, a category the activity instance belongs to, a risk score (e.g., based on whether the activity instance relates to a suspected fraud or a confirmed fraud), and/or a financial value the activity instance involves. For example, the first computing device may receive one or more first attributes associated with the first activity instance. The one or more first attributes may comprise the time when the application is submitted, the financial value involved in the first activity instance (e.g., $3000 if the first user applies for a credit card with a $3000 credit limit), the category of the first activity (e.g., account application), a first risk score determined by a model configured to determine whether the first activity instance, viewing in isolation, is risky or not (e.g., a risk score outputted by the application fraud model 350 depicted in FIG. 3B). The one or more first attributes may also comprise a risk threshold or any other information relevant to the first activity instance.

The first activity instance may be associated with a suspected fraud activity, or the first activity instance may be associated with a confirmed fraud activity. For example, during an account application process, an application that comprises falsified information may be considered a confirmed fraud action, while an application that comprises a representation that is unable to be verified may be considered a suspected fraud action.

At step 410, the first computing device may receive a second activity instance of the plurality of activity instances. The second activity instance may occur or be detected a second time. The second time may be a point in time after the first time. For example, the first time may be a time when the applicant applies for a bank account. The second time may be a time when the bank account holder uses the account to make a transaction. The second activity instance may be received from a third computing device that executes one of the fraud models 345 to 375 in FIG. 3B. For example, the third computing device may be one of the computing devices 220a to 220n as depicted in FIG. 2. The first computing device may determine that the second activity instance belongs to a second category. The second category may be different from the first category, or the second category may be the same as the first category. For example, the third computing device may be a computing device 220n configured to authenticate a transaction. The second category may be transaction requests.

The first computing device may receive one or more second attributes associated with the second activity instance. For example, the one or more second attributes may comprise the time when the transaction is requested, the financial value involved in the second activity instance (e.g., $500 if the first user requests $500 to be transferred to another party), the category of the second activity (e.g., transaction requests), a second risk score determined by a model configured to determine whether the second activity instance, viewing in isolation, is risky or not (e.g., a risk score outputted by the transaction fraud model 355 depicted in FIG. 3B). The one or more second attributes may also comprise a risk threshold or any other information relevant to the second activity instance.

The second activity instance may be associated with a suspected fraud activity or may be associated with a confirmed fraud activity. For example, during a transaction process, a transaction declined by the third computing device 220n due to the suspicious location may be considered a suspected fraud action (e.g., as the suspicious transaction location may either because a fraudulent transaction occurs or because the first user is traveling), while an unauthorized transaction, which was later reported either by the first user or by the other party in the transaction, may be considered a confirmed fraud activity.

It is appreciated that, for simplicity, the description in FIG. 4 uses the first activity instance and the second activity instance as an example, but any number of activity instances and/or any category of activity instances may be received and analyzed together.

At step 415, the first computing device may aggregate the plurality of activity instances (e.g., the first activity instance and the second activity instance). The aggregation may be made via an API. The first computing device may aggregate the first activity instance and the second activity instance by normalizing the one or more first attributes associated with the first activity instance and the one or more second attributes associated with the second activity instance. For example, the plurality of computing devices 220a-220n may send activity instances in different formats. The API may comprise a data reception module configured to decode data packets in different formats. The API may further comprise a normalization module configured to convert the different formats into a standard format. For example, the API may convert attributes in each activity instance, of the plurality of activity instances, into a standard activity table. Each activity instance may be associated with a plurality of fields in the standard table. Each field may be associated with a type of attribute of the activity instance. For example, the standard activity table may comprise a first field for an attribute associated with the time when the activity instance occurs, a second field for an attribute associated with the category the activity instance belongs to, a third field for an attribute associated with a monetary value the activity instance involves, and/or a fourth field for an attribute associated with a risk score evaluated by a model (e.g., a model 340-375 as depicted in FIG. 3B). For example, as shown in FIG. 5B (described in further detail below), the standard table 540 may comprise two fields (time field 555 and category field 560) for each of the first instance 570 and the second instance 580 respectively. It is appreciated that the fields and the attributes in each field are merely examples, other numbers of fields and/or other types of attributes are possible. The normalization may be helpful, for example, to improve the function of a computing system (e.g., the computing system 200 in FIG. 2) because, by normalizing the plurality of activity instances, the computing system may use data, produced by different devices in different formats, in a way that the computing system may not be able to utilized previously.

At step 420, the first computing device may determine a first likelihood of a future fraud instance (or an ongoing fraud instance that has not become apparent) associated with the first user. The first computing device may determine the first likelihood by inputting the normalized attributes (e.g., the one or more first normalized attributes and the one or more second normalized attributes) into a machine learning model (e.g., the machine learning model 205 as depicted in FIG. 2). The machine learning model may be trained to output, based on an input of normalized attributes associated with each of a plurality of activity instances, a likelihood of a future fraud instance (or an ongoing fraud instance that has not become apparent) of a user associated with the plurality of input activity instances. The way the machine learning model determines the likelihood may be described in greater detail below in connection with FIG. 5A.

At step 425, the first computing device may determine whether the first likelihood exceeds a threshold. A likelihood that exceeds the threshold may indicate a fraud (e.g., first party fraud) is likely to occur during a time period in the future (or have been ongoing). If the first likelihood exceeds the threshold, the method may proceed to step 435. If the first likelihood does not exceed the threshold, the method may proceed to step 440.

At step 435, the first computing device may send, based on the first likelihood exceeding a threshold, an alert. The alert may be sent to one or more of the plurality of computing devices 220a to 220n (e.g., depicted in FIG. 2). The first computing device may send (e.g., together with the alert) a request to take a preventive or remedial action associated with the first user account. For example, the remedial action may comprise denial of a future transaction request or suspending an account associated with the first user.

At step 440, the first computing device may store the first and/or second instances in a database (e.g., the database 210 depicted in FIG. 2). The stored first and/or second instances may be utilized in a variety of ways. For example, the first and/or second instances may be retrieved at a future time point (e.g., after a third activity instance, associated with the first user, is received by the first computing device). The first computing device may input the first and/or second instances, together with the newly received third activity instance, to the machine learning model. The machine learning model may further determine a second likelihood of fraud associated with the first user based on the new input. While the first and/or second instances, viewing alone, may not be enough to predict a high likelihood of fraud, the first and/or second instances, viewing together with the third activity instance, may be enough to predict a high likelihood of fraud.

In another example, the first and/or second instances, together with the first likelihood, may be used as a set of training data to further improve the machine learning model. The first computing device may receive, from one or more of the plurality of computing devices 220, an investigation result regarding whether a fraud eventually occurs or whether evidence of an ongoing fraud is eventually found. The investigation result may be used to either positively or negatively reinforce the machine learning model, depending on whether the investigation result conforms with the prediction. The machine learning model may adjust its weights and parameters (e.g., as described in FIG. 3A) accordingly.

Additionally or alternatively, the first computing device 201 may comprise a coherent fraud decision overwrite engine. The fraud decision overwrite engine may be configured to use the first instance, the second instance, and/or the first likelihood to make corrections to each individual model (e.g., each of the payment fraud model 340, account takeover model 345, application fraud model 350, transaction fraud model 355, and false transaction model 365 as described in FIG. 3B). For example, if the first likelihood indicates a low likelihood of any fraud but one of the individual models indicates a high risk of fraud, the overwrite engine may generate instructions to correct the initial decision made by the individual model. For example, the first likelihood may also be used as training data to further train or improve each of the individual models. In addition to the first likelihood, the training data may also include an explanation regarding how the first likelihood is determined.

The steps of method 400 may be modified, omitted, or performed in other orders, or other steps added as appropriate.

FIG. 5A is a flow diagram depicting method 500 for fraud detection in accordance with one or more illustrative aspects discussed herein. The steps in method 500 may be performed by a system comprising, for example, fraud decision server 201 and machine learning model 205 as may be shown in FIG. 2.

At step 510, a machine learning model (e.g., a machine learning model 205 in FIG. 2) may receive a plurality of activity instances. The plurality of activity instances may be received from the first computing device. The plurality of activity instances may be the plurality of activity instances described in connection with FIG. 4. Each of the plurality of activity instances may be associated with one or more attributes associated with the activity instance. For example, the one or more attributes may comprise at least one of: a time associated with the activity instance, a category the activity instance belongs to, a risk score (e.g., based on whether the activity instance relates to a suspected fraud or a confirmed fraud), a risk threshold, and/or a financial value the activity instance involves. The one or more attributes may be the one or more normalized attributes as described in FIG. 4.

The plurality of activity instances may comprise the first activity instance and/or the second activity instance as described in FIG. 4. For example, the first activity instance may be a misrepresentation made by a first user during an application of a bank account. The second activity instance may be a transaction declined due to a suspicious transaction location.

FIG. 5B shows an illustrative table 540 comprising attributes associated with a first activity instance 570 and a second activity instance 580. As shown in FIG. 5B, each activity instance may be associated with two attributes, for example, the time attribute 555 and the category attribute 560. For example, the table 540 may indicate that the first instance 570's time attribute 555 is Mar. 10, 2023, and the first instance 570's category attribute 560 is application misrepresentation. The one or more first attributes associated with the first instance 570 may indicate the first instance 570 is an application misrepresentation made on Mar. 10, 2023. The table 540 may indicate that the second instance 580's time attribute 555 is May 23, 2023, and the second instance 580's category attribute 560 is a declined transaction. The one or more second attributes associated with the second instance 580 may indicate the second instance 580 is a declined transaction made on May 23, 2023.

Referring back to FIG. 5A, at step 520, the machine learning model may assign one or more first weights to each of the plurality of activity instances. The one or more first weights may be assigned to a respective activity instance, for example, based on attributes associated with the activity instance. For example, the one or more first weights may comprise a category weight. The category weight may be based on which category the activity instance belongs to. Consistent with the example in FIG. 5B, a category weight of 10 may be assigned to the first instance 570, for example, based on the first activity instance belonging to an application misrepresentation. A category weight of 5 may be assigned to the second instance 580, for example, based on the second activity instance belonging to a declined transaction. In another example, the one or more first weights may comprise a financial value weight. The financial value weight may be based on the amount of financial value involved in the activity instance (e.g., a higher weight may be assigned if a higher financial value is involved). In another example, the one or more first weights may comprise a preliminary risk determined based on the activity instance (e.g., based on viewing the activity instance as an isolated instance). For example, a higher weight may be assigned to a confirmed fraud, and a lower weight may be assigned to a suspected fraud. The risk may be determined, for example, based on one or more of the models 340 to 375 as described in FIG. 3B.

At step 525, the machine learning model may assign one or more second weights to each of the plurality of activity instances. The one or more second weights may be assigned to an activity instance, based on a relationship between the respective activity instance and other activity instances of the plurality of activity instances. For example, the one or more second weights may comprise a temporal relationship weight. The temporal relationship weight may be assigned to an activity instance based on a temporal relationship between the respective activity instance and other activity instances. For example, the temporal relationship may be a time interval between the activity instance and another activity instance, of the plurality of activity instances, that is closest in time with the activity instance. Consistent with the example in FIG. 5B, the second instance 580 may be assigned a temporal relationship weight of 5 given the second instance 580 occurs two months after the first instance 570 occurs. A higher value may be assigned, for example, if the time interval between the activity instance and other instances is shorter.

For example, the one or more second weights may comprise a category relationship weight. The category relationship weight may be assigned to an activity instance, for example, based on the similarity or dissimilarity of the category to which the activity instance belongs to, compared to other activity instances of the plurality of activity instances. A higher value may be assigned, for example, if the category is the same as (or similar to) most of the other activity instances.

At step 530, the machine learning model may determine a likelihood of a future fraud instance (or an ongoing fraud instance) based on the assigned weights. For example, the machine learning model may determine an overall score for the plurality of activity instances based on the assigned weights. For example, the machine learning model may determine the overall score based on a sum of all weights assigned to the plurality of activity instances. In another example, the machine learning model may determine the overall score based on an average weight assigned to each of the plurality of activity instances. If the overall score exceeds a threshold, the machine learning model may determine that there is a high likelihood of a future fraud instance (or an ongoing fraud instance). The machine learning model may output the result (e.g., to the first computing device as described in FIG. 4).

The steps of method 500 may be modified, omitted, or performed in other orders, or other steps added as appropriate. It is appreciated that method 500 is merely an example, and the machine learning model 205 may predict future fraud instances in a way additional to or alternative to method 500. For example, the machine learning model 205 may use community-based dynamic graph learning to predict future fraud.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. Accordingly, the scope of the invention should be determined not by the embodiments illustrated, but by the appended claims and their equivalents.

What is claimed is:

1. A method comprising:
receiving, by a first computing device from a second computing device, a first activity instance, associated with a first user, occurred at a first time;
receiving, by the first computing device from a third computing device, a second activity instance, associated with the first user, occurred at a second time;
aggregating, via an application programming interface (API), the first activity instance and the second activity instance by normalizing:
one or more first attributes associated with the first activity instance; and
one or more second attributes associated with the second activity instance;
determining, by inputting the one or more first normalized attributes and the one or more second normalized attributes into a machine model, a first likelihood of a future fraud instance associated with the first user, wherein the machine learning model is trained to output, based on an input of normalized attributes associated with each of a plurality of fraud instances, a likelihood of a future fraud instance of a user associated with the plurality of input fraud instances; and
sending, based on the first likelihood exceeding a threshold, an alert.

2. The method of claim 1, wherein the determining the first likelihood comprises using the machine learning model to:
assign, based on the first activity instance belonging to a first fraud category, a first weight to the one or more first normalized attributes;
assign, based on the second activity instance belonging to a second fraud category, a second weight to the one or more second normalized attributes, wherein the first weight is different from the second weight; and
determine, based on the first weight and the second weight, the likelihood.

3. The method of claim 2, wherein the first fraud category is one of:
a payment fraud,
an application fraud, or
a transaction fraud.

4. The method of claim 1, wherein the determining the likelihood is based on a time duration between the first time and the second time.

5. The method of claim 1, wherein the first activity instance is associated with a suspicious activity, and wherein the second activity instance is associated with a confirmed fraud activity.

6. The method of claim 1, wherein:
the one or more first attributes comprise a first risk score determined by a second machine learning model trained to predict a risk score associated with fraud instances of a first fraud category; and
the one or more second attributes comprise a second risk score determined by a third machine learning model trained to predict a risk score associated with fraud instances of a second fraud category.

7. The method of claim 1, further comprising sending a request to take a remedial action that comprises at least one of:
denial of a future transaction request; or
suspending an account associated with the first user.

8. A system comprising:
a first computing device; and
a second computing device;
wherein the first computing device is configured to:
receive, from a second computing device, a first activity instance, associated with a first user, occurred at a first time;
receive, from a third computing device, a second activity instance, associated with the first user, occurred at a second time;
aggregate, via an application programming interface (API), the first activity instance and the second activity instance by normalizing:
one or more first attributes associated with the first activity instance; and
one or more second attributes associated with the second activity instance;
determine, by inputting the one or more first normalized attributes and the one or more second normalized attributes into a machine model, a first likelihood of a future fraud instance associated with the first user, wherein the machine learning model is trained to output, based on an input of normalized attributes associated with each of a plurality of fraud instances, a likelihood of a future fraud instance of a user associated with the plurality of input fraud instances; and
send, based on the first likelihood exceeding a threshold, an alert; and
wherein the second computing device is configured to:
send, to the first computing device, the first activity instance.

9. The system of claim 8, wherein the first computing device is configured to determine the first likelihood by using the machine learning model to:
assign, based on the first activity instance belonging to a first fraud category, a first weight to the one or more first normalized attributes;
assign, based on the second activity instance belonging to a second fraud category, a second weight to the one or more second normalized attributes, wherein the first weight is different from the second weight; and
determine, based on the first weight and the second weight, the likelihood.

10. The system of claim 9, wherein the first fraud category is one of:
a payment fraud,
an application fraud, or
a transaction fraud.

11. The system of claim 8, wherein the first computing device is configured to determine the likelihood based on a time duration between the first time and the second time.

12. The system of claim 8, wherein the first activity instance is associated with a suspicious activity, and wherein the second activity instance is associated with a confirmed fraud activity.

13. The system of claim 8, wherein:
the one or more first attributes comprise a first risk score determined by a second machine learning model trained to predict a risk score associated with fraud instances of a first fraud category; and
the one or more second attributes comprise a second risk score determined by a third machine learning model trained to predict a risk score associated with fraud instances of a second fraud category.

14. The system of claim 8, further wherein the first computing device is further configured to send a request to take a remedial action that comprises at least one of:
denial of a future transaction request; or
suspending an account associated with the first user.

15. A non-transitory computer-readable medium storing computer instructions that, when executed by one or more processors, cause a first computing device perform of actions comprising:
receiving, from a second computing device, a first activity instance, associated with a first user, occurred at a first time;
receiving, from a third computing device, a second activity instance, associated with the first user, occurred at a second time;
aggregating, via an application programming interface (API), the first activity instance and the second activity instance by normalizing:
one or more first attributes associated with the first activity instance; and
one or more second attributes associated with the second activity instance;
determining, by inputting the one or more first normalized attributes and the one or more second normalized attributes into a machine model, a first likelihood of a future fraud instance associated with the first user, wherein the machine learning model is trained to output, based on an input of normalized attributes associated with each of a plurality of fraud instances, a likelihood of a future fraud instance of a user associated with the plurality of input fraud instances; and
sending, based on the first likelihood exceeding a threshold, a request to take a remedial action that comprises at least one of:
denial of a future transaction request; or
suspending an account associated with the first user.

16. The non-transitory computer-readable medium of claim 15, wherein the instructions, when executed by the one or more processors, cause the determining the first likelihood by using the machine learning model to:
assign, based on the first activity instance belonging to a first fraud category, a first weight to the one or more first normalized attributes;
assign, based on the second activity instance belonging to a second fraud category, a second weight to the one or more second normalized attributes, wherein the first weight is different from the second weight; and
determine, based on the first weight and the second weight, the likelihood.

17. The non-transitory computer-readable medium of claim 16, wherein the first fraud category is one of:
a payment fraud,
an application fraud, or
a transaction fraud.

18. The non-transitory computer-readable medium of claim 15, wherein wherein the instructions, when executed by the one or more processors, cause the determining the likelihood based on a time duration between the first time and the second time.

19. The non-transitory computer-readable medium of claim 15, wherein the first activity instance is associated with a suspicious activity, and wherein the second activity instance is associated with a confirmed fraud activity.

20. The non-transitory computer-readable medium of claim 15, wherein:
the one or more first attributes comprise a first risk score determined by a second machine learning model trained to predict a risk score associated with fraud instances of a first fraud category; and
the one or more second attributes comprise a second risk score determined by a third machine learning model trained to predict a risk score associated with fraud instances of a second fraud category.
